(19) United States
(12) Patent Application Publication
(10) Pub. No.: US 2020/0120277 A1
(43) Pub. Date: Apr. 16, 2020

(54) POWER SUPPLY DEVICE TO IMAGE SENSOR, CAMERA DEVICE AND ELECTRONIC DEVICE BOTH HAVING SUCH POWER SUPPLY DEVICE MOUNTED THEREIN

(71) Applicant: New Shicoh Motor Co., Ltd., Jiashan (CN)

(72) Inventor: Tatsuki WADE, Yamato (JP)

(73) Assignee: New Shicoh Motor Co., Ltd., Jiashan (CN)

(21) Appl. No.: 16/598,287

(22) Filed: Oct. 10, 2019

(30) Foreign Application Priority Data
Oct. 12, 2018 (JP) 2018-193238

(51) Int. Cl. H04N 5/232; H04N 5/217; H04N 5/225

(52) U.S. Cl. CPC H04N 5/23241; G03B 17/02; H04N 5/2253; H04N 5/2173

(57) ABSTRACT

A power supply device to an image sensor comprising an image sensor assembly in which an image sensor of the rectangular form is mounted on a substrate; and a circuit substrate that is bendable and/or flexible and from which an electric power is supplied to the image sensor. The circuit substrate includes two circuit substrates each of which is provided on each of the sides on which there are one set of two sides of the image sensor facing opposite each other. The circuit substrate includes a first connecting portion to be connected to the image sensor assembly, a coupling portion extending from the first connecting portion, and a second connecting portion provided on one end of the coupling portion in the direction in which the coupling portion is extending. The circuit substrate is bent on the boundary portion between the first connecting portion and the coupling portion.

### CROSS-REFERENCE TO RELATED APPLICATION

This application claims priority to Japanese Patent Application No. 2018-193238 filed Oct. 12, 2018, the disclosure of which is hereby incorporated in its entirety by reference.

### FIELD OF THE INVENTION

The present invention relates to a power supply device to an image sensor. The image sensor having the power supply device is mounted in a camera device. Also, the image sensor having the power supply device is mounted in a camera device which is mounted in an electronic device such as the smartphone.

### BACKGROUND OF THE INVENTION

It is known to the prior art that there is a camera device that is designed to be used in obtaining a subject image by forming the subject image on an image sensor used for producing image data. In connection with such known camera device, it is also known to the prior art that there is a camera device that is equipped with the image blur suppression mechanism and is capable of moving the image sensor to follow the subject image affected by the image blurring effects caused by shaking the camera and thereby taking the subject image from which the image blurring effects have been suppressed.

As the system for suppressing any image blurring effects caused by shaking the camera, there is a sensor-shifting system in which an image sensor is moved in the direction intersecting with the incident direction of the light. This system is provided for moving the image sensor to follow the subject image affected by the image blurring effects. An example of the image blur suppression mechanism is disclosed in JP2007-114485A in which it is described that the image blur suppression mechanism includes a mounting stage in which the image sensor is mounted, a X axial direction stage in which a permanent magnet is placed and a Y axial direction stage in which a coil is so located as to face opposite the permanent magnet. The X axial direction stage is fixed to the camera body, and the X direction and the Y direction are driven by the actuator using the combination of the coil and the magnet. This image blur suppression mechanism includes a power supplying mechanism that allows the image sensor assembly including an image sensor mounted on its board or substrate and the fixing portion provided in the camera device to be interconnected electrically through FPC (Flexible Printed Circuit). This FPC is so flexible as to overlap itself and is extending in the Z direction, thereby ensuring the image sensor can be moved smoothly or without any problems.

### SUMMARY OF THE INVENTION

The power supply device that has the structure disclosed in JP2007-114485A is designed for use with the usual digital camera. In this structure, the FPC is so flexible as to overlap itself and is extending in the Z direction. Thus, the Z direction has the great thickness. It was therefore difficult to apply this power supply device to the camera device mounted in the electronic device such as the smartphone having a thin thickness and which is difficult to construct firmly.

The present invention solves the problems described above, it is therefore an object of the present invention to provide a power supply device to a thin image sensor that can be mounted on any thin electronic device such as the smartphone, a camera device and an electronic device on both of which the power supply device can be mounted.

A power supply device to an image sensor described in the present application comprising:

an image sensor assembly in which an image sensor of the rectangular form is mounted on a substrate; and

a circuit substrate that is bendable and/or flexible and from which an electric power is supplied to said image sensor, wherein

said circuit substrate includes:

two circuit substrates each of which is provided on each of the sides on which there are one set of two sides of the image sensor facing opposite each other;

a first connecting portion to be connected to said image sensor assembly;

a coupling portion extending from said first connecting portion; and

a second connecting portion provided on one end of said coupling portion in the direction in which said coupling portion is extending, said circuit substrate is bent on the boundary portion between said first connecting portion and said coupling portion toward the direction of the height of said image sensor assembly, and said coupling portion is bent or curved toward the direction intersecting with the direction in which said coupling portion is extending.

In accordance with the present invention, a power supply device to a thin image sensor that can be mounted on any thin electronic device such as the smartphone, a camera device and an electronic device on both of which the power supply device can be mounted can be provided.

### BRIEF DESCRIPTION OF THE DRAWINGS

FIGS. 1A through 1D illustrate an example of the first embodiment of the present invention;

FIG. 2 is a perspective view illustrating the power supply device shown in FIGS. 1A-1D;

FIGS. 3A through 3C illustrate an example of the second embodiment of the present invention;

FIG. 4 is a perspective view illustrating the power supply device shown in FIGS. 3A-3C;

FIGS. 5A through 5D illustrate an example of the third embodiment of the present invention;

FIG. 6 is a perspective view illustrating the power supply device shown in FIGS. 5A-5D;

FIGS. 7A and 7B illustrate an example of the fourth embodiment of the present invention;

FIGS. 8A through 8C illustrate an example of the fifth embodiment of the present invention;

FIGS. 9A through 9C illustrate an example of the sixth embodiment of the present invention;

FIGS. 10A and 10B illustrate a variation of the sixth embodiment of the present invention; and

FIGS. 11A through 11D illustrate an example of the seventh embodiment of the present invention.

### BEST MODES OF EMBODYING THE INVENTION

The following description presents the embodiments of the present invention by referring to the respective accompanying drawings.

### First Embodiment

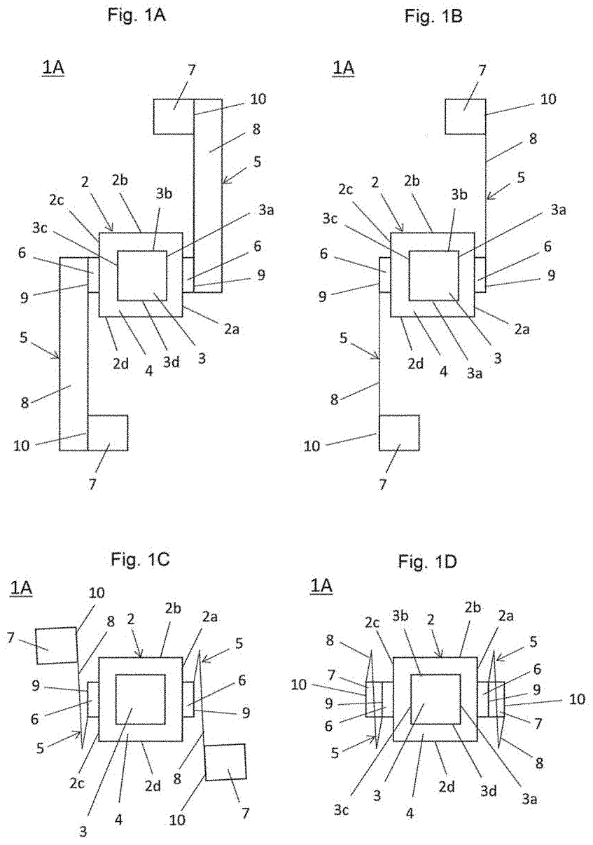

FIG. 1A is a developed view illustrating the power supply device 1A to an image sensor in accordance with the first embodiment (“the power supply device to an image sensor” will hereinafter be referred to simply as “the power supply device”). In accordance with the first embodiment, the power supply device 1A includes an image sensor assembly 2 and two circuit substrates 5, 5. The image sensor assembly 2 is provided such that it includes an image sensor 3 of the rectangular form that is mounted on substrate 4. The circuit substrates 5, 5 are flexible and/or bendable and supply the electric power to the image sensor 3. It should be noted, however, that the circuit elements 5, 5 are provided not only to supply the power to the image sensor 3 but also to deliver signals to the image sensor 3 and cause signals to be received by other devices.

The image sensor assembly 2 is housed in a container (not shown) which also accommodates the camera device and the like in which the power supply device 1A according to the first embodiment can be employed. And, the image sensor assembly 2 effects the straight-line movement toward the direction inside the surface of the image sensor 3 with respect to the container and/or the rotary movement with respect to the container that occurs around the direction of the normal to the surface of the image sensor 3 on which the incident light is received. Herein, it should be understood that the direction inside the surface of the image sensor 3 means the direction in which the surface of the image sensor 3 on which the incident light is received is extending.

In the first embodiment, the substrate 4 has the rectangular form that corresponds to the form of the image sensor 3. The image sensor assembly 2 has the sides 2a, 2b, 2c, 2d each of which corresponds to each respective one of the sides 3a, 3b, 3c, 3d of the image sensor 3.

Each of the circuit substrates 5, 5 has one end connected to the image sensor assembly 2 and the other end connected to a power supply section (not shown) housed in the not shown container. The circuit substrates 5, 5 receive the power from the not shown power supply section, through which the power is then supplied to the image sensor 3 included on the image sensor assembly 2.

The circuit substrates 5, 5 are mainly made of FPC and is therefore bendable and/or flexible. Each of the circuit substrates 5, 5 has the predetermined thickness and width, and is extending between one end thereof connected to the image sensor assembly 2 and the other end thereof connected to the power supply section.

In the first embodiment, each of the circuit substrates 5, 5 includes first connecting portions 6, 6 to be connected to the image sensor assembly 2, coupling portions 8, 8 extending from the first connecting portions 6, 6 and second connecting portions 7, 7 located on the respective one end of the direction in which the coupling portions 8, 8 is extending.

In the first embodiment, each of the circuit substrates 5, 5 is connected to one set of two sides 2a, 2c of the image sensor assembly 2 facing opposite each other on the side on which there are one set of two sides 3a, 3c of the image sensor 3. Desirably, those two circuit substrates 5, 5 are located symmetrically with respect to the image sensor assembly 2.

In the first embodiment, each of the first connecting portions 6, 6 is connected to each respective one of the one set of two sides 2a, 2c of the image sensor assembly 2 facing opposite each other. For example, the first connecting portions 6, 6 may be connected to the center part of the one set of two sides 2a, 2c of the image sensor assembly 2 facing opposite each other.

Each of the two circuit substrates 5. 5 is flexible (bendable) toward the direction of the height of the image sensor assembly 2 on each of the boundary portions 9, 9 between the first connecting portion 6 and the coupling portion 8. The coupling portions 8, 8 are directed toward the second connecting portions 7, 7 and are extending toward the direction inside the surface of the image sensor 3. The image sensor assembly 2 has the thickness in its height direction that is determined, depending on the width of the coupling portions 8, 8. Each of the boundary portions 9, 9 is located in parallel with the direction in which the coupling portions 8, 8 are extending.

The process in which, beginning with its developed view and finishing with its 3D form, the power supply device 1A in the first embodiment will be completed, will next be described. The two circuit substrates 5, 5, the first connecting portions 6, 6, the second connecting portions 7, 7, the coupling portions 8, 8, the boundary portions 9, 9 and the boundary portions 10, 10 have the identical structure, respectively, and so only one of the two circuit substrates and only one of those respective portions will be described below.

FIG. 1B represents the process that begins with the state shown in FIG. 1A and finishes with the state in which the coupling portion 8 is bent toward the direction of the upper side (toward the front on the paper) of the image sensor assembly 2 on the boundary portion 9, thereby allowing the circuit substrate 5 to be bent toward the height direction of the image sensor assembly 2. It is shown in FIG. 1B that the second connecting portion 7 is bent with respect to the coupling portion 8 on the boundary portion 10 between the second connecting portion 7 and the coupling portion 8, and that the first connecting portion 6 and the second connecting portion 7 are located on the plane that is common to each other.

FIG. 1C illustrates the state in which, beginning with the state in FIG. 1B, the coupling portion 8 is bent one time toward the direction intersecting with the direction in which the coupling portion 8 is extending. FIG. 1D illustrates the state in which, beginning with the state in FIG. 1C, the coupling portion 8 is further bent one more time toward the direction intersecting with the direction in which the coupling portion 8 is extending. It has been described that the coupling portion 8 is bent, but it may be curved.

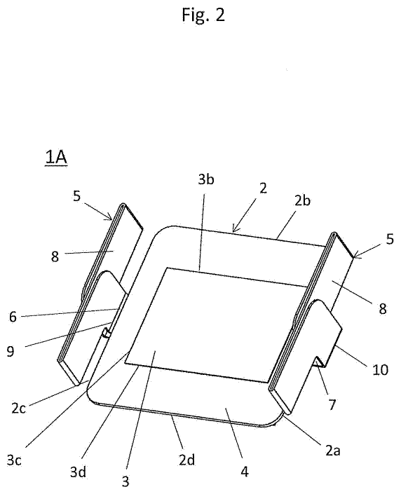

FIG. 2 is a perspective view and represents the state in which, beginning with the state in the developed view shown in FIG. 1A, the coupling portion 8 is bent in the order of FIGS. 1B, 1C and 1D and the second connecting portion 7 is then folded toward the lower side position of the image sensor assembly 20. At this time, the second connecting portion 7 will be so located as to face opposite the side opposed to the side on which the image sensor 3 in the image sensor assembly 2 is mounted, and the second connecting portion 7 will then be connected to the power supply section in the container in which the image sensor assembly 2 is mounted in the camera device and the like is housed. Then, the power will be supplied to the image sensor assembly 2 through the second connecting portion 7.

In the first embodiment, the circuit substrate 5 will be bent on the boundary portion 9 in the height direction of the image sensor assembly 2 and the coupling portion 8 will then be made to extend only in the direction inside the surface of the image sensor assembly 2. Accordingly, the power supply device 1A can have the thickness that is reduced in the height direction corresponding to the height direction of the image sensor assembly 2. As the second connecting portion 7 is folded toward the lower side position of the image sensor assembly 2, the power supply device 1A can also have the size that is reduced in the width direction.

The coupling portion 8 can have the sufficient length. Thus, the image sensor assembly 2 can be moved without being affected by the spring-like action of the circuit substrate 5. This ensures that the image sensor 3 in the image sensor assembly 2 can be moved accurately with respect to the container.

The first embodiment is provided such that, beginning with the state in FIG. 1A, the circuit substrate 5 can be bent toward the height direction of the image sensor assembly 2 by folding the coupling portion 8 toward the upper side direction of the image sensor assembly 2 at the boundary portion 9. As a variation of the first embodiment, beginning with the state in FIG. 1A, the circuit substrate 5 can be bent toward the height direction of the image sensor assembly 2 by folding the coupling portion 8 toward the under side direction of the image sensor assembly 2 at the boundary portion 9.

The coupling portion 8 may include a slit that is provided in the direction in which the coupling portion 8 is extending, although this is omitted to illustrate in the first embodiment. This ensures that the image sensor 3 in the image sensor assembly 2 can be moved accurately with respect to the container without being affected by the spring-like action of the circuit substrate 5.

The first embodiment may be varied in which the circuit substrate 5 having the structure described above further include additional two circuit substrates. In the variation of the first embodiment, each of those additional two circuit substrates 5, 5 is connected to each respective one of another set of sides 2b, 2d of the image sensor assembly 2 facing opposite each other on the side there are another set of sides 3b, 3d of image sensor 3 facing opposite each other. Also, in the first embodiment, each of the first connecting portion 6, 6 is connected to the middle way of each of the sides as illustrated in FIGS. 1A to 1D, but this is not limited to connect the first connecting portion 6, 6 to the middle way of each of the sides.

It should also be noted that the two or four circuit substrates 5 may be assembled together into one unit that may be located on the opposite side of the side on which the image sensor 3 in the image sensor assembly 2 is located.

### Second Embodiment

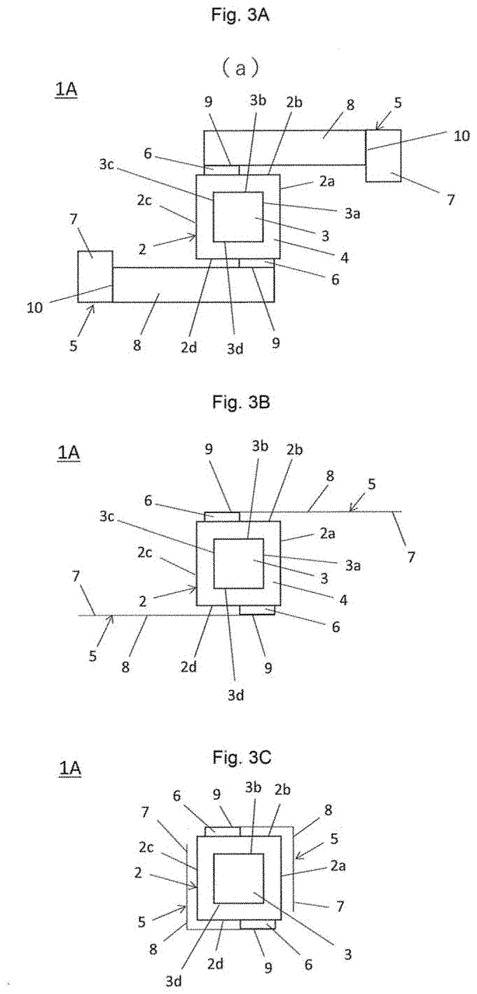

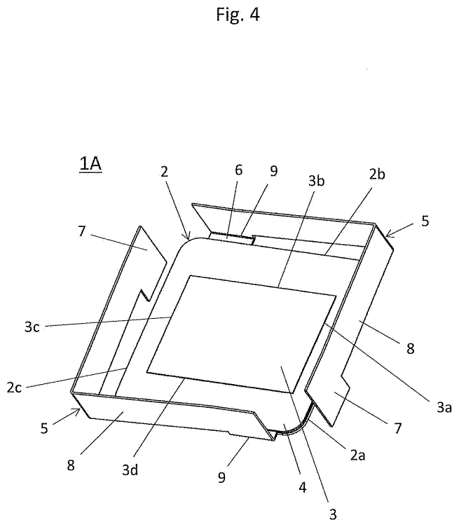

The second embodiment is now described by using FIGS. 3A-3D and FIG. 4. Those parts or portions which are common to those in the first embodiment are given common reference numerals and are not described below. FIG. 3A is the developed view that corresponds to that in FIG. 1A, FIG. 3B corresponds to FIG. 1B and FIG. 3C corresponds to FIGS. 1C and 1D.

In the second embodiment like the first embodiment, it is shown in FIGS. 3B and 3C that the circuit substrate 5 is folded toward the upper side direction (toward the front on the paper) of the image sensor assembly 2 at the boundary portion 9, and is bent toward the height direction of the image sensor assembly 2. The boundary portion 9 is located in parallel with the direction in which the coupling portion 8 is extending. One of the coupling portions 8 is extending along the side 2d of the image sensor assembly 2, is bent toward the direction intersecting with the coupling portion's extending direction at the positions corresponding to the corners of the sides 2d and 2c of the image sensor assembly 2, and is extending along the side 2c of the image sensor assembly 2. The other coupling portion 8 is extending along the side 2b of the image sensor assembly 2, is bent toward the direction intersecting (orthogonal) with the coupling portion's extending direction at the positions corresponding to the corners of the sides 2b and 2a of the image sensor assembly 2, and is extending along the side 2a of the image sensor assembly 2.

As shown in FIGS. 3C and 4, the second connecting portion 7 is not folded toward the lower side direction of the image sensor assembly 2, and is formed on the same plane as the coupling portion 8. At this time, the second connecting portion 7 is provided to face the side directed toward the inside enclosing the image sensor assembly 2 from the outside thereof, and will then be connected to the power supply section in the container.

That is to say, in the second embodiment, the second connecting portion 7 is provided at the positions corresponding to the sides 2a and 2c adjoining the sides 2b and 2d to which the first connecting portions 6, 6 will be connected. In this case, as illustrated in FIGS. 3A-3C, in order to ensure that the coupling portions 8, 8 can be made longer, one combination of the first connecting portion 6 and the second connecting portion 7 is located away from the corner formed by the sides 2b and 2a. And the other combination of the first connecting portion 6 and the second connecting portion 7 is located away from the corner formed by the sides 2d and 2c.

### Third Embodiment

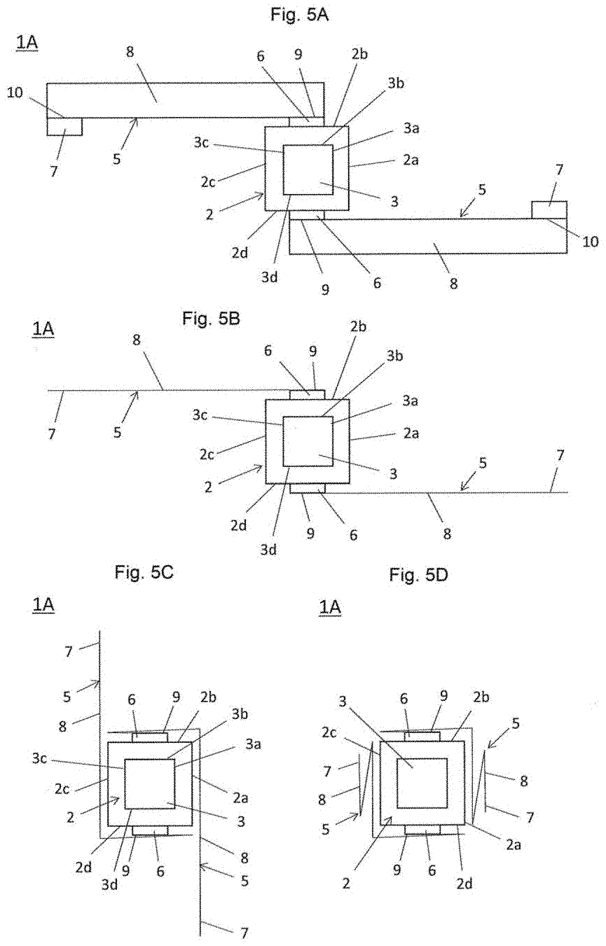

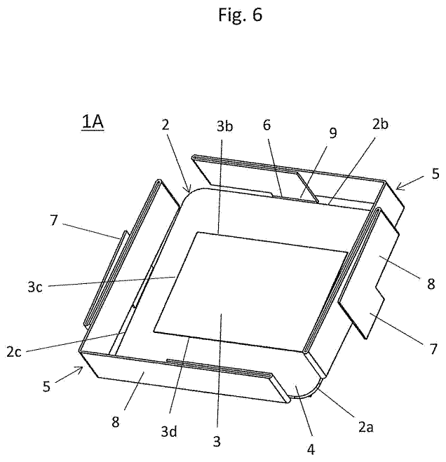

The third embodiment is now described by using FIGS. 5A-5D and FIG. 6. The third embodiment is provided by combining the first embodiment with the second embodiment. Those parts or portions which are common to those in the first embodiment are given common reference numerals and are not described below. FIG. 5A is the developed view that correspond to that in FIG. 1A. FIG. 5B corresponds to FIG. 1B and FIGS. 5C and 5D correspond to FIGS. 1C and 1D.

In the third embodiment like the first embodiment, the coupling portion 8 is folded toward the upper side direction of the image sensor assembly 2 on the boundary portion 9, thereby allowing the circuit substrate 5 to be bent toward the height direction of the image sensor assembly 2. The boundary portion 9 is located in parallel with the direction in which the coupling portion 8 is extending.

For the one circuit substrate 5 that is connected on the side 2d of the image sensor assembly 2, as shown in FIG. 5C, the coupling portion 8 extending along the side 2d is bent at an angle of substantially 180 degrees at the position corresponding to the corner of the sides 2d and 2a. For the other one circuit substrate 5, furthermore, the coupling portion 8 extending along the side 2d is bent at an angle of 90 degrees at the position corresponding to the corner of the sides 2d and 2c.

For the other circuit substrate 5 that is connected on the side 2b of the image sensor assembly 2, the coupling portion 8 extending along the side 2b is bent at an angle of substantially 180 degrees at the position corresponding to the corner of the sides 2b and 2c. For the other circuit substrate 5, furthermore, the coupling portion 8 extending along the side 2b is bent at an angle of 90 degrees at the position corresponding to the corner of the sides 2b and 2c.

For the one circuit substrate 5, furthermore, as shown in FIG. 5 (d), the coupling portion 8 extending along the side 2c is bent at an angle of substantially 180 degrees at the position corresponding to the corner of the sides 2c and 2b. For the other circuit substrate 5, the coupling portion 8 extending along the side 2a is bent at an angle of substantially 180 degrees at the position corresponding to the corner of the side 2a and 2b.

As shown in FIGS. 5D and 6, the second connecting portion 7 is formed on the same plane as the coupling portion 8. This is the same as for the second embodiment.

In the third embodiment, the power supply device 1A includes the coupling portion 8 that is longer than those in the first embodiment and the second embodiment and has the small size that is equal to that in the second embodiment.

### Fourth Embodiment

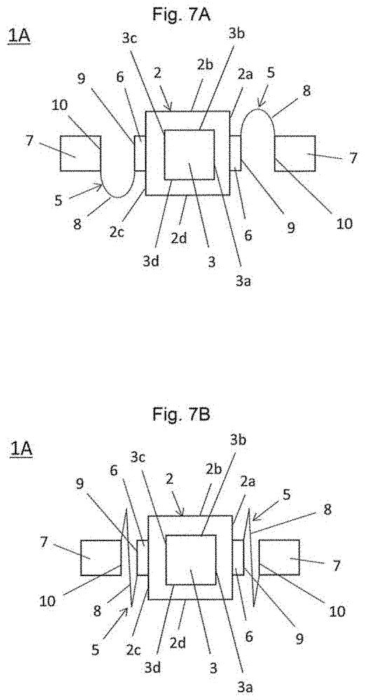

The fourth embodiment is now described by using FIGS. 7A and 7B. Those parts or portions that are common to those in the first embodiment are given common reference numerals, and are not described below.

FIGS. 7A and 7B correspond to FIG. 1D, showing the state in which the power supply device has been completed.

It is shown in FIG. 7A that the coupling portion 8 is folded on the boundary portion 9 toward the upper side direction (toward the front on the paper) of the image sensor assembly 2, thereby allowing the circuit substrate 5 to be bent toward the height direction of the image sensor assembly 2 and allowing the coupling portion 8 to be curved toward the direction intersecting the direction in which the coupling portion 8 is extending. It is also shown that on the boundary portion 10 between the second connecting portion 7 and the coupling portion 8, the second connecting portion 7 is bent so that it can face the outside of the coupling portion 8 and the first connecting portion 6 and the second connecting portion 7 can be located on the same plane.

In FIG. 7B, the coupling portion 8 is folded on the boundary portion 9 toward the upper side direction (toward the front on the paper) of the image sensor assembly 2, thereby allowing the circuit substrate 5 to be bent toward the height direction of the image sensor assembly 2 and allowing the coupling portion 8 to be bent two times toward the direction intersecting with the direction in which the coupling portion 8 is extending. It is also shown that on the boundary portion 10, the second connecting portion 7 is folded so that it can face the outside of the coupling portion 8, and the first connecting portion 6 and the second connecting portion 7 can be located on the same plane.

The second connecting portion 7 will then face the plane which is located on the outside of the image sensor assembly 2 and parallel with the image sensor assembly 2. As one example, the container mentioned above includes a protruded portion that is so formed as to project from the inner wall side to the inner side of the container and to correspond to the sides 2a and 2c of the image sensor assembly 2. The second connecting portion 7 may be connected to the side facing the upper or lower side of the protruded portion and parallel with the image sensor assembly 2. The power supply section can be placed on that side, to which the second connecting portion 7 can be connected. This ensures that the power supply device can be made more easily.

### Fifth Embodiment

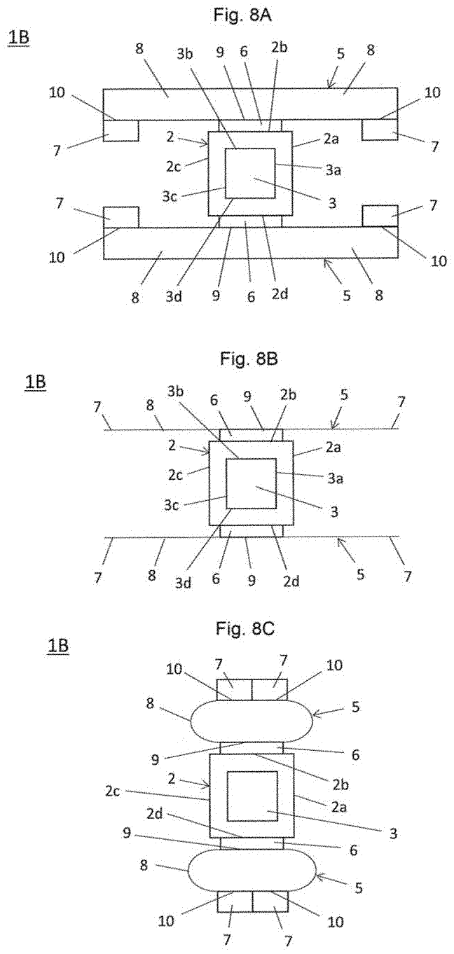

The fifth embodiment is now described by using FIGS. 8A-8C. Those parts or portions that are common to those in the first embodiment are given common reference numerals and are not described below.

FIG. 8A is the developed view and corresponds to FIG. 1A in the first embodiment. FIG. 8B corresponds to FIG. 1B and FIG. 8C corresponds to FIG. 1D.

In the fifth embodiment, the coupling portion 8 is extending so that the boundary portion 9 between the first connecting portion 6 and the coupling portion 8 can be located on the middle way of the direction in which the coupling portion 8 is extending. The boundary portion 9 is located in parallel with the direction in which the coupling portion 8 is extending. And the second connecting portions 7, 7 are provided on the opposite ends of the direction in which the coupling portion 8 is extending, respectively.

It is shown in FIG. 8B that, beginning with the state in FIG. 8A, the coupling portion 8 is folded on the boundary portion 9 toward the upper side (toward the front on the paper) of the image sensor assembly 2, thereby allowing the circuit substrate 5 to be bent toward the height direction to the image sensor assembly 2. It is also shown in FIG. 8C that the coupling portions 8, 8 extending on the right and left sides, respectively, from the boundary portion 9 are curved toward the direction intersecting with the direction in which the coupling portions 8, 8 are extending. On the boundary portion 10, the second connecting portions 7, 7 are folded with respect to the respective coupling portions 8, 8, thereby allowing the two second connecting portions 7, 7 to be joined together. The two second connecting portions 7, 7 may be located away from each other. The second connecting portion 7 may be located such that the first connecting portion 6 and the second connecting portion 7 can be located on the same plane and may be folded toward the inner side as this is done in the first embodiment or may be bent toward the outer side as this is done in the fourth embodiment. Like the second embodiment, the second connecting portion 7 need not be bent on the boundary portion 10.

In the power supply device 1B in the fifth embodiment, one circuit substrate 5 is located line-symmetrically with respect to the image sensor assembly 2, and the force exerted on the image sensor assembly 2 can be equal. When the image sensor assembly 2 is to be moved toward the direction inside the surface, therefore, the rotary force not required for this movement will not be exerted on the image sensor assembly 2. This ensures that the image sensor 3 in the image sensor assembly 2 can be moved more accurately.

### Sixth Embodiment

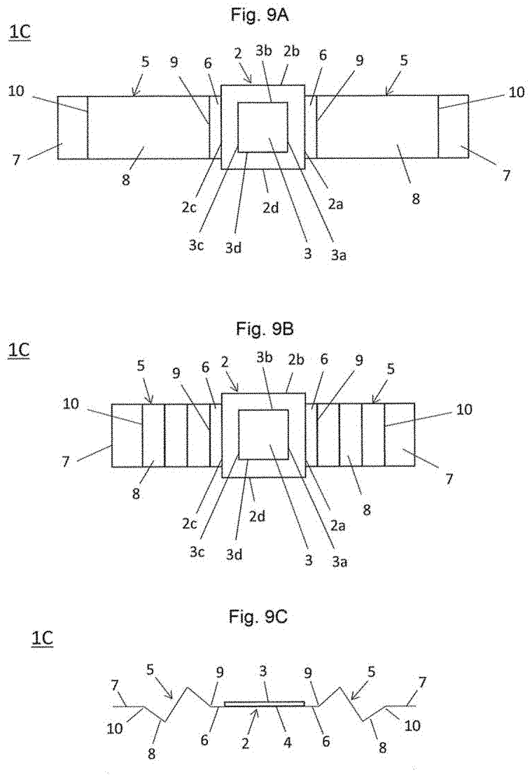

The sixth embodiment is now described by using FIGS. 9A-9C. Those parts or portions that are common to those in the first embodiment are given common reference numerals and are nor described below.

FIG. 9A is the developed view that corresponds to that in FIG. 1A in the first embodiment. FIG. 9B is the view in which the power supply device 1B including the circuit substrate 5 as it is bent is seen from the same direction as FIG. 9A. FIG. 9C is the view in which FIG. 9B is seen from the lateral side. In the sixth embodiment, the circuit substrates 5, 5 are connected to the respective sides 2a and 2c of the image sensor assembly 2 corresponding to the one set of sides 3a, 3c of the image sensor 3 facing opposite each other. The coupling portions 8, 8 are extending in the direction intersecting with the sides 2a and 2c. The boundary portion 9 is located at right angles to the direction in which the coupling portion 8 is extending.

As shown in FIGS. 9B and 9C, the coupling portion 8 is bent on the boundary portion 9 between the first connecting portion 6 and the coupling portion 8 toward the upper side direction of the image sensor assembly 2, thereby allowing the circuit substrate 5 to be bent toward the height direction of the image sensor assembly 2. The coupling portion 8 is bent toward the lower side direction of the image sensor assembly 2 and in the direction intersecting with the direction in which the coupling portion 8 is extending, thereby allowing the circuit substrate 5 to be bent toward the height direction of the image sensor assembly 2. And then, the coupling portion 8 is further bent toward the upper side of the image sensor assembly 2. Thereby, the circuit substrate 5 is bent toward the height direction of the image sensor assembly 2.

On the boundary portion 10 between the second connecting portion 7 and the coupling portion 8, the second connecting portion 7 is bent with respect to the coupling portion 8, thereby allowing the first connecting portion 6 and the second connecting 7 to be located on the same plane.

In the sixth embodiment, the coupling portion 8 is bent or curved toward the height direction of the image sensor assembly 2. It is desirable in this case that the size of the coupling portion 8 formed by bending or curving it toward the height direction of the image sensor assembly 2 is less than the width of the coupling portion 8. This ensures that the power supply device 1C can have the smaller thickness in the height direction of the image sensor assembly 2.

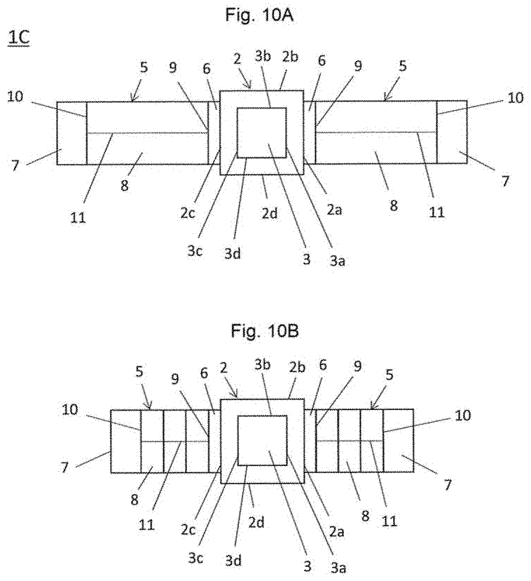

The power supply device 1C in FIGS. 10A and 10B is formed by adding an optional slit 11 to the power supply device 1C in FIGS. 9A-9C, the slit 11 extending toward the direction in which the coupling portion 8 is extending. The slit 11 may have the width as determined. This ensures that the effect of the spring-like action of the circuit substrate 5 can be reduced as described earlier and the movement of the image sensor 3 included on the image sensor assembly 2 can occur more accurately.

### Seventh Embodiment

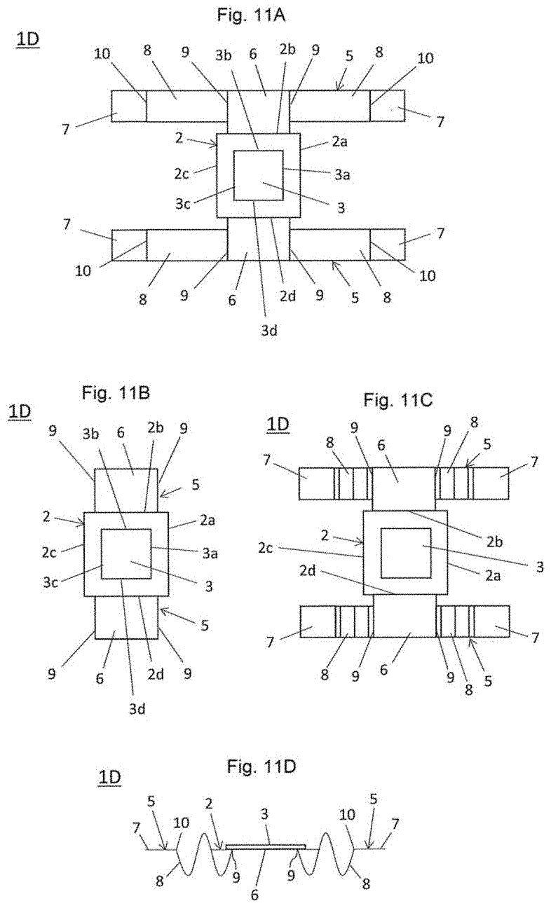

The seventh embodiment is now described by using FIGS. 11A-11D. Those parts or portions that are common to those in the first embodiment are given common reference numerals and are not described below.

FIG. 11A is the developed view that corresponds to that in FIG. 1A in the first embodiment. FIG. 11B corresponds to FIG. 1B and FIG. 11C corresponds to FIG. 1D. FIG. 11D is the view as FIG. 11C is viewed from the lateral side.

In the seventh embodiment, the boundary portion 9 is provided on each of the opposite ends of the width direction of the first connecting portion 6. Each of the coupling portions 8, 8 is extending toward the direction intersecting with the corresponding boundary portion 9. The second connecting portion 7 is located on the opposite side of the first connecting portion 6 of the coupling portion 8. The boundary portion 10 is located in parallel with the boundary portion 9.

It may appear from FIG. 11B that the coupling portion 8 is bent on the boundary portion 9 toward the lower side direction of the image sensor assembly 2, thereby allowing the circuit substrate 5 to be bent toward the height direction of the image sensor assembly 2. As shown in FIGS. 11C and 11D, furthermore, the coupling portion 8 is curved. And, the second connecting portion 7 is bent toward the outer side.

In the seventh embodiment, the coupling portion 8 is curved toward the height direction of the image sensor assembly 2. Like the sixth embodiment, it is desirable in this case that the size of the coupling portion 8 formed by curving it toward the height direction of the image sensor assembly 2 is less than the width of the coupling portion 8. This ensures that the power supply device 1D can have the smaller thickness in the height direction of the image sensor assembly 2.

(Embodiment of Camera Device)

In the camera device according to the embodiment thereof, any one of the power supply devices 1A through 1D to an image sensor described above in accordance with the first through seventh embodiments are employed.

Any one of the power supply devices 1A through 1D has the structure such that it includes the image sensor assembly 2 which contains the image sensor 3 of the rectangular form mounted on substrate 4 and the flexible and/or bendable circuit substrate 5 from which the power is supplied to the image sensor 3. The circuit substrate 5 includes the first connecting portion 6 to be connected to the image sensor assembly 2, the coupling portion 8 extending from the first connecting portion 6 and the second connecting portion 7 located to one the opposite ends of the direction in which the coupling portion 8 is extending. The second connecting portion 7 is connected to the power supply section within the camera device according to the embodiment thereof in which any one of the power supply devices 1A through 1D according to the first through seventh embodiments is employed.

Structurally, the circuit substrate 5 is bent on the boundary portion 9 between the first connecting portion 6 and the coupling portion 8 toward the height direction of the image sensor assembly 2, and extending toward the direction inside the surface of the image sensor 3, and then, the circuit substrate 5 is bent or curved toward the direction intersecting with the direction in which the circuit substrate 5, 5 is extending.

For this reason, any one of the power supply devices 1A through 1D in the height direction of the image sensor assembly 2 has the thickness that is determined, depending on the width of the coupling portion 8.

Thus, the camera device in which any one of the power supply devices 1A through 1D is employed can have the comparatively smaller thickness. This means that it will be possible to provide the camera device having the smaller thickness.

(Embodiment of Electronic Device)

The electronic device according to the embodiment thereof can have the camera device according to the embodiment thereof incorporated therein.

The electronic device such as the smartphone whose thickness has thus been reduced can be provided.

Although the present invention has been described above with reference to several preferred embodiments of the present invention, it should be understood that the present invention is not limited to those embodiments and may be varied in various ways without departing from the spirit and scope of the invention as defined in the appended claims.

### DESCRIPTION OF REFERENCE NUMERALS

1A, 1B, 1C. 1D power supply device to an image sensor
2 image sensor assembly
3 image sensor
4 substrate
5 circuit substrate
6 first connecting portion
7 second connecting portion
8 coupling portion
9 boundary portion between the first connecting portion and the coupling portion
10 boundary portion between the coupling portion and the second connecting portion
11 slit

1. A power supply device to an image sensor comprising:
an image sensor assembly in which an image sensor of the rectangular form is mounted on a substrate; and
a circuit substrate that is bendable and/or flexible and from which an electric power is supplied to said image sensor, wherein
said circuit substrate includes:
two circuit substrates each of which is provided on each of the sides on which there are one set of two sides of the image sensor facing opposite each other;
a first connecting portion to be connected to said image sensor assembly;
a coupling portion extending from said first connecting portion; and
a second connecting portion provided on one end of said coupling portion in the direction in which said coupling portion is extending, said circuit substrate is bent on the boundary portion between said first connecting portion and said coupling portion toward the direction of the height of said image sensor assembly, and said coupling portion is bent or curved toward the direction intersecting with the direction in which said coupling portion is extending.

2. The power supply device to an image sensor as defined in claim 1, said circuit substrate further includes additional two circuit substrates each of which is provided on each of the sides on which there are another set of two sides of the image sensor facing opposite each other.

3. The power supply device to an image sensor as defined in claim 1, wherein said boundary portion is located in parallel with the direction in which said coupling portion is extending.

4. The power supply device to an image sensor as defined in claim 3, wherein said coupling portion is extending so that said boundary portion is located on the middle way of the direction in which said coupling portion is extending and said second connecting portion is located on each of the opposite ends of the direction in which said coupling portion is extending.

5. The power supply device to an image sensor as defined in claim 1, wherein said boundary portion is provided at a right angle with respect to the direction in which said coupling portion is extending.

6. The power supply device to an image sensor as defined in claim 5, wherein said boundary portion is provided on each of the opposite ends of the width direction of said first connecting portion.

7. The power supply device to an image sensor as defined in claim 1, wherein said coupling portion includes a slit provided in the direction in which said coupling portion is extending.

8. The power supply device to an image sensor as defined in claim 1, said second connecting portion is provided such that it faces opposite the opposite side of the side on which said image sensor included on said image sensor assembly is mounted.

9. The power supply device to an image sensor as defined in claim 1, wherein said second connecting portion is provided such that it faces the side which enclosing said image sensor assembly from the outside thereof and directed toward the inside in which said image sensor assembly is enclosed.

10. The power supply device to an image sensor as defined in claim 1, wherein said second connecting portion is provided such that it faces the side which is located on the outside of said image sensor assembly and parallel with said image sensor assembly.

11. A camera device which has the power supply device to an image sensor as defined in claim 1 mounted therein.

12. An electronic device which has the camera device as defined in claim 11 mounted therein.
